(19) United States
(12) Patent Application Publication
(10) Pub. No.: US 2019/0241698 A1
(43) Pub. Date: Aug. 8, 2019

(54) HARDENER COMPOSITION AND ASSOCIATED FORMING METHOD, UNCURED AND CURED EPOXY RESIN COMPOSITIONS, AND ARTICLE

(71) Applicant: SABIC GLOBAL TECHNOLOGIES B.V., Bergen op Zoom (NL)

(72) Inventor: Edward Norman PETERS, Selkirk, NY (US)

(21) Appl. No.: 16/319,862

(22) PCT Filed: Jul. 5, 2017
(86) PCT No.: PCT/US2017/040675

§ 371 Date: Jan. 23, 2019

Related U.S. Application Data
(60) Provisional application No. 62/366,183, filed on Jul. 25, 2016.

(51) Int. Cl. C08G 59/42; C08G 59/62; C08G 59/24; C08L 63/00; C08J 5/04

(52) U.S. Cl. CPC C08G 59/4284; C08G 59/621; C08G 59/4238; C08G 59/24; C08L 63/00; C08J 2363/00; C08J 5/043; C08J 5/044; C08J 5/046; C08L 2205/16; C08J 5/042

(57) ABSTRACT

A hardener composition is prepared by blending a low intrinsic viscosity hydroxyl-diterminated poly(phenylene ether), and an anhydride having structure (1) where q, R^{a}, and X are defined herein. The hardener composition exhibits glass transition temperature of −46 to +110° C., which is characteristic of the blend and distinct from the glass transition temperatures of the individual components. Also described are a method of forming the hardener composition, a curable epoxy composition incorporating the hardener composition, a cured composition formed from the curable epoxy composition, and an article that includes the cured composition.

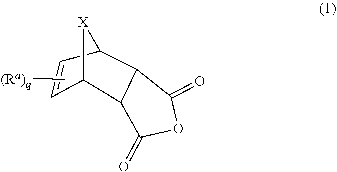

### BACKGROUND OF THE INVENTION

Incorporation of a poly(phenylene ether) into an epoxy resin can provide the resulting cured epoxy resin with benefits including increased toughness, increased heat resistance, decreased moisture absorption, and decreased dielectric constant. However, achieving dissolution of the poly(phenylene ether) in the epoxy resin typically requires either (1) high temperatures such that the poly(phenylene ether) reacts with the epoxy before completely dissolving, thereby increasing viscosity and shortening pot life for the poly(phenylene ether)-containing epoxy resin composition, or (2) the use of a solvent that will dissolve the poly(phenylene ether) and the epoxy resin, thereby complicating the process with solvent addition, solvent removal, and solvent recycling or disposal steps. If solvent removal is not complete and the cure temperature exceeds the solvent boiling point, then any residual solvent can result in void formation.

There is therefore a desire for methods of incorporating a poly(phenylene ether) into an epoxy resin that minimize or avoid the use of solvents and the premature reaction of the poly(phenylene ether) with the epoxy resin.

### BRIEF SUMMARY OF EMBODIMENTS OF THE INVENTION

One embodiment is a hardener composition comprising, based on the total weight of the composition: 1 to 80 weight percent of a hydroxyl-diterminated poly(phenylene ether) having an intrinsic viscosity of 0.03 to 0.2 deciliter per gram measured by Ubbelohde viscometer at 25° C. in chloroform; and 20 to 99 weight percent of an anhydride having structure (1)

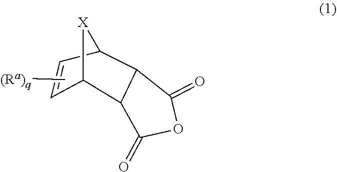

wherein q is zero or 1, R^{a} is C₁₋₆-alkyl, and X is —CH₂—, —(CH₂)₂—, —O—, or —S—; wherein the composition exhibits a single glass transition temperature in the range −80 to +200° C., wherein the single glass transition temperature has a value of −46 to +110° C.; and wherein the composition comprises zero to 1 weight percent total of solvents for the hydroxyl-diterminated poly(phenylene ether).

Another embodiment is a method of forming a hardener composition, the method comprising: blending 1 to 80 weight percent of a hydroxyl-diterminated poly(phenylene ether) having an intrinsic viscosity of 0.03 to 0.2 deciliter per gram measured by Ubbelohde viscometer at 25° C. in chloroform; and 20 to 99 weight percent of an anhydride having structure (1)

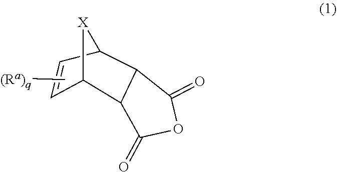

wherein q is zero or 1, R^{a} is C₁₋₆-alkyl, and X is —CH₂—, —(CH₂)₂—, —O—, or —S—; to form the composition; wherein said blending is conducted in the presence of less than or equal to 1 weight percent total of solvents for the hydroxyl-diterminated poly(phenylene ether); wherein said blending is conducted at a temperature less than or equal to 150° C. ; and wherein the composition exhibits a single glass transition temperature in the range −80 to +200° C., wherein the single glass transition temperature has a value of −46 to +110° C.

Another embodiment is a curable epoxy composition comprising: a hydroxyl-diterminated poly(phenylene ether) having an intrinsic viscosity of 0.03 to 0.2 deciliter per gram measured by Ubbelohde viscometer at 25° C. in chloroform; an anhydride having structure (1)

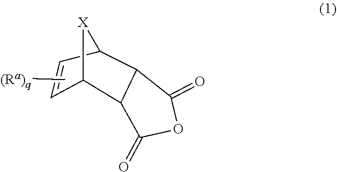

wherein q is zero or 1, R^{a} is C₁₋₆-alkyl, and X is —CH₂—, —(CH₂)₂—, —O—, or —S—; and an epoxy resin; wherein the hydroxyl-diterminated poly(phenylene ether), the anhydride having structure (1), and the epoxy resin are present in amounts effective to produce a mole ratio of epoxy groups derived from the epoxy resin to hydroxyl groups derived from the hydroxyl-diterminated poly(phenylene ether) of 5:1 to 400:1, and a mole ratio of epoxy groups derived from the epoxy resin to anhydride groups derived from anhydride having structure (1) of 0.5:1 to 50:1.

Another embodiment is a cured composition comprising the product of at least partially curing the curable composition in any of its variations.

Another embodiment is an article comprising the cured composition in any of its variations.

These and other embodiments are described in detail below.

### DETAILED DESCRIPTION OF THE INVENTION

The present inventor has determined that incorporation of poly(phenylene ether) into an epoxy resin is facilitated by blending the poly(phenylene ether) with a particular class of anhydride hardeners under conditions effective to form a homogeneous mixture in which little or no reaction between the poly(phenylene ether) and the anhydride hardener has occurred. The homogeneous mixture can subsequently be blended with epoxy resin under mild conditions that do not cause substantial reaction of the epoxy resin with either the poly(phenylene ether) or the anhydride hardener. All this can be accomplished in the substantial or complete absence of solvents for the poly(phenylene ether).

One embodiment is the homogeneous mixture of the poly(phenylene ether) and the anhydride hardener. Specifically, this embodiment is a composition comprising, based on the total weight of the composition: 1 to 80 weight percent of a hydroxyl-diterminated poly(phenylene ether) having an intrinsic viscosity of 0.03 to 0.2 deciliter per gram measured by Ubbelohde viscometer at 25° C. in chloroform; and 20 to 99 weight percent of an anhydride having structure (1)

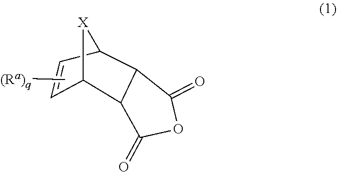

wherein q is zero or 1, R^{a} is C₁₋₆-alkyl, and X is —CH₂—, —(CH₂)₂—, —O—, or —S—; wherein the composition exhibits a single glass transition temperature in the range −80 to +200° C., wherein the single glass transition temperature has a value of −46 to +110° C.; and wherein the composition comprises zero to 1 weight percent total of solvents for the hydroxyl-diterminated poly(phenylene ether).

The composition comprises a hydroxyl-diterminated poly(phenylene ether). The term “hydroxyl-diterminated” means that the poly(phenylene ether) has, on average, 1.5 to 2.5, or 1.8 to 2.2, phenolic hydroxyl groups per molecule. In some embodiments, the hydroxyl-diterminated poly(phenylene ether) has the structure

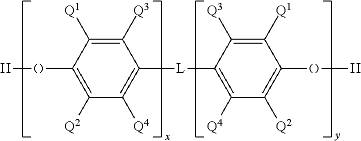

wherein each occurrence of Q¹ and Q² is independently selected from the group consisting of halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; each occurrence of Q³ and Q⁴ is independently selected from the group consisting of hydrogen, halogen, unsubstituted or substituted C₁-C₁2 hydrocarbyl provided that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; x and y are independently 0 to 30, or 0 to 20, or 0 to 15, or 0 to 10, or 0 to 8, provided that the sum of x and y is at least 2, or at least 3, or at least 4; and L has the structure

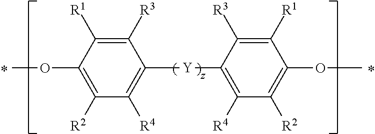

wherein each occurrence of R¹ and R² and R³ and R⁴ is independently selected from the group consisting of hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; z is 0 or 1; and Y is selected from the group consisting of

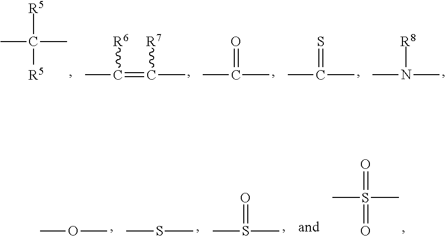

wherein each occurrence of R⁵-R⁸ is independently hydrogen, C₁-C₁₂ hydrocarbyl, or C₁-C₆ hydrocarbylene wherein the two occurrence of R⁵ collectively form a C₄-C₁₂ alkylene group.

As used herein, the term “hydrocarbyl”, whether used by itself, or as a prefix, suffix, or fragment of another term, refers to a residue that contains only carbon and hydrogen. The residue may be aliphatic or aromatic, straight-chain, cyclic, bicyclic, branched, saturated, or unsaturated. It may also contain combinations of aliphatic, aromatic, straight chain, cyclic, bicyclic, branched, saturated, and unsaturated hydrocarbon moieties. The hydrocarbyl residue, when so stated however, may contain heteroatoms over and above the carbon and hydrogen members of the substituent residue. Thus, when specifically noted as containing such heteroatoms, the hydrocarbyl residue may also contain one or more carbonyl groups, amino groups, hydroxyl groups, or the like, or it may contain heteroatoms within the backbone of the hydrocarbyl residue. As one example, Q¹ may be a di-n-butylaminomethyl group formed by reaction of a terminal 3,5-dimethyl-1,4-phenyl group with the di-n-butylamine component of an oxidative polymerization catalyst.

In some embodiments, each occurrence of Q¹ and Q² is methyl, each occurrence of Q³ is hydrogen, each occurrence of Q⁴ is hydrogen or methyl, the sum of x and y is 2 to 15, each occurrence of R¹ and R² and R³ and R⁴ is independently hydrogen or methyl, and Y has the structure

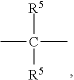

wherein each occurrence of R⁵ is independently hydrogen, C₁-C₁₂ hydrocarbyl, or C₁-C₆ hydrocarbylene wherein the two occurrences of R⁵ collectively form a C₄-C₁₂ alkylene group.

In some embodiments, the hydroxyl-diterminated poly(phenylene ether) comprises a copolymer of 2,6-xylenol and 2,2-bis(3,5-dimethyl-4-hydroxyphenyl)propane having the structure

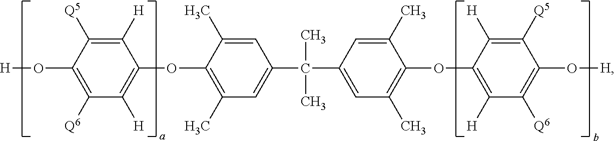

wherein each occurrence of Q⁵ and Q⁶ is independently methyl or di-n-butylaminomethyl; and each occurrence of a and b is independently 0 to about 20, provided that the sum of a and b is at least 2, or at least 3, or at least 4. Hydroxyl-diterminated poly(phenylene ether) having this structure can be synthesized by oxidative copolymerization of 2,6-xylenol and 2,2-bis(3,5-dimethyl-4-hydroxyphenyl)propane in the presence of a catalyst comprising di-n-butylamine

The hydroxyl-diterminated poly(phenylene ether) having an intrinsic viscosity of 0.03 to 0.2 deciliter per gram measured by Ubbelohde viscometer at 25° C. in chloroform. Within this range, the intrinsic viscosity can be 0.04 to 0.17 deciliter per gram, or 0.05 to 0.15 deciliter per gram.

The composition comprises the hydroxyl-diterminated poly(phenylene ether) in an amount of 1 to 80 weight percent, based on the total weight of the composition. Within this range, the hydroxyl-diterminated poly(phenylene ether) amount can be 10 to 70 weight percent, or 20 to 60 weight percent, or 30 to 50 weight percent.

In addition to the hydroxyl-diterminated poly(phenylene ether), the composition comprises an anhydride having structure (1)

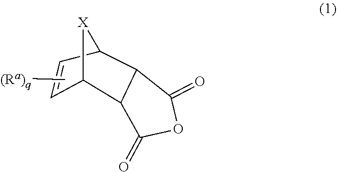

wherein q is zero or 1, R^{a} is C₁₋₆-alkyl, and X is —CH₂—, —(CH₂)₂—, —O—, or —S—. In some embodiments, q is 1.

When R^{a} is present (i.e., when q is 1), the R^{a} substituent can be attached to the 1, 4, 5, 6, or 7 position of the norbornene skeleton. Position numbering is shown below.

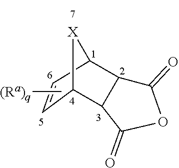

It will be understood that when R^{a} is attached to the 7 position, X is —CH₂— or —(CH₂)₂—, and R^{a} replaces one of the hydrogen atoms of —CH₂— or —(CH₂)₂—.

The anhydride having structure (1) can be exo or endo, or a mixture of exo and endo. In some embodiments, it is endo. Structures of exo and endo anhydrides are shown below.

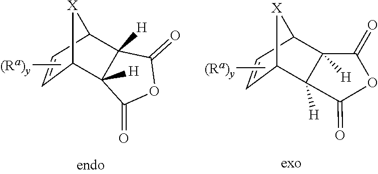

Specific examples of the anhydride having structure (1) include 5-norbornene-2 ,3-dicarboxylic anhydride, methyl-5-norbornene-2,3-dicarboxylic anhydride, ethyl-5-norbornene-2,3-dicarboxylic anhydride, propyl-5-norbornene-2,3-dicarboxylic anhydride, iso-propyl-5-norbornene-2,3-dicarboxylic anhydride, butyl-5-norbornene-2,3-dicarboxylic anhydride, sec-butyl-5-norbornene-2,3-dicarboxylic anhydride, tert-butyl-5-norbornene-2,3-dicarboxylic anhydride, pentyl-5-norbornene-2,3-dicarboxylic anhydride, neo-pentyl-5-norbornene-2,3-dicarboxylic anhydride, hexyl-5-norbornene-2,3-dicarboxylic anhydride, cyclohexyl-5-norbornene-2,3-dicarboxylic anhydride, and combinations thereof.

In some embodiments of the anhydride having structure (1), q is 1, R^{a} is methyl, and X is —CH₂—.

The composition comprises the anhydride having structure (1) in an amount of 20 to 99 weight percent, based on the total weight of the composition. Within this range, the anhydride amount can be 30 to 90 weight percent, or 40 to 80 weight percent, or 50 to 70 weight percent.

The hardener composition can, optionally, include a curing promoter for epoxy resin. As used herein, the term “curing promoter” refers to a compound that promotes or catalyzes the epoxy curing reaction without reacting stoichiometrically with the epoxy resin. Curing promoters for epoxy resin include, for example, triethylamine, tributylamine, dimethylaniline, diethylaniline, a-methylbenzyldimethylamine, N,N-dimethylaminoethanol, N,N-dimethylaminocresol, tri(N,N-dimethylaminomethyl)phenol, 2-methylimidazole, 2-ethylimidazole, 2-laurylimidazole, 2-heptadecylimidazole, 2-phenylimidazole, 4-methylimidazole, 4-ethylimidazole, 4-laurylimidazole, 4-heptadecylimidazole, 2-phenyl-4-methylimidazole, 2-phenyl-4-hydroxymethylimidazole, 2-ethyl-4-methylimidazole, 2-ethyl-4-hydroxymethylimidazole, 1-cyanoethyl-4-methylimidazole, 2-phenyl-4,5-dihydroxymethyllimidazole, and combinations thereof. When present, the curing promoter can be used in an amount of 0.005 to 1 weight percent, specifically 0.01 to 0.5 weight percent, based on the total weight of the composition.

The hardener composition minimizes or excludes solvents for the hydroxyl-diterminated poly(phenylene ether). Specifically, the hardener composition comprises zero to 1 weight percent total of solvents for the hydroxyl-diterminated poly(phenylene ether). Within this limit, the solvent amount can be zero to 0.1 weight percent, or zero weight percent. Examples of solvents for the hydroxyl-diterminated poly(phenylene ether) include C₃-C₈ ketones (including acetone, methyl ethyl ketone, and methyl isobutyl ketone), C₄-C₈ ethers (including dioxane and tetrahydrofuran), C₃-C₆ N,N-dialkylamides (including N,N-dimethylacetamide), C₆-C₁₀ aromatic hydrocarbons (including toluene and anisole), C₁-C₃ chlorinated hydrocarbons (including chloroform and dichloromethane), C₃-C₆ alkyl alkanoates (including ethyl acetate, isopropyl acetate, and butyl acetate), C₂-C₆ alkyl cyanides (including acetonitrile), C₂-C₄ dialkyl sulfoxides (including dimethylsulfoxide), and combinations thereof.

The hardener composition can, optionally, exclude epoxy resin. In some embodiments, the composition excludes any thermoset resin.

In a very specific embodiment of the hardener composition, the hydroxyl-diterminated poly(phenylene ether) comprises a copolymer of 2,6-xylenol and 2,2-bis(3,5-dimethyl-4-hydroxyphenyl)propane having an intrinsic viscosity of 0.05 to 0.15 deciliter per gram; in structure (1), q is 1, R^{a} is methyl, and X is —CH₂—; the composition comprises 20 to 60 weight percent of the hydroxyl-diterminated poly(phenylene ether), and 40 to 80 weight percent of the anhydride having structure (1); the composition excludes thermoset resin; and the single glass transition temperature has a value of −40 to +1° C.

The hardener composition is characterized by two temperature ranges. The broader temperature range of −80 to +200° C. is the range over which one would expect to find the glass transition temperatures of the hydroxyl-diterminated poly(phenylene ether) and the anhydride having structure (1), if they were present (which they are not). The narrower temperature range of −46 to +110° C. is the range over which a single glass transition temperature is observed for the hardener composition. This single glass transition temperature is characteristic of a homogeneous mixture of the hydroxyl-diterminated poly(phenylene ether) and the anhydride having structure (1). The temperature range in which the single glass transition temperature is observed varies depending on the identities and amounts of the hydroxyl-diterminated poly(phenylene ether) and the anhydride having structure (1). In some embodiments, the range over which the single glass transition temperature is observed is −45 to +50° C., or −40 to +1° C., or −35 to −18° C. To summarize, the two temperature ranges collectively require that the hardener composition exhibits a single glass transition temperature that is characteristic of the homogeneous mixture of the hydroxyl-diterminated poly(phenylene ether) and the anhydride having structure and differs from the glass transition temperatures of those components.

Another embodiment is a method of forming a hardener composition, the method comprising: blending, based on the total weight of the hardener composition, 1 to 80 weight percent of a hydroxyl-diterminated poly(phenylene ether) having an intrinsic viscosity of 0.03 to 0.2 deciliter per gram measured by Ubbelohde viscometer at 25° C. in chloroform; and 20 to 99 weight percent of an anhydride having structure (1)

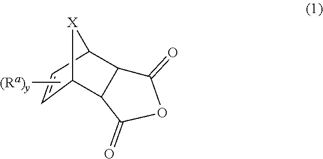

wherein q is zero or 1, R^{a} is C₁₋₆-alkyl, and X is —CH₂—, —(CH₂)₂—, —O—, or —S—, to form the composition; wherein said blending is conducted in the presence of less than or equal to 1 weight percent total of solvents for the hydroxyl-diterminated poly(phenylene ether); wherein said blending is conducted at a temperature less than or equal to 150° C.; and wherein the composition exhibits a single glass transition temperature in the range −80 to +200° C., wherein the single glass transition temperature has a value of −46 to +110° C.

All of the above-described variations of the hardener composition apply as well to the method of forming the hardener composition. For example, the amount of the hydroxyl-diterminated poly(phenylene ether) can be 1 to 80 weight percent, or 10 to 70 weight percent, or 20 to 60 weight percent, or 30 to 50 weight percent, based on the total weight of the hardener composition. As another example, the intrinsic viscosity of the hydroxyl-diterminated poly(phenylene ether) can be 0.03 to 0.2 deciliter per gram, or 0.04 to 0.17 deciliter per gram, or 0.05 to 0.15 deciliter per gram. As another example, the weight percent of the anhydride having structure (1) can be 20 to 99 weight percent, or 30 to 90 weight percent, or 40 to 80 weight percent, or 50 to 70 weight percent, based on the total weight of the hardener composition. As another example, the hardener composition exhibits a single glass transition temperature in the range −80 to +200° C., wherein the single glass transition temperature has a value of −46 to +110° C., or −45 to +50° C., or −40 to +1° C., or −35 to −18° C.

In the method of forming the hardener composition, blending is conducted in the presence of less than or equal to 1 weight percent, or less than or equal to 0.1 weight percent, or zero weight percent, total of solvents for the hydroxyl-diterminated poly(phenylene ether), wherein weight percent values are based on the total weight of the hardener composition. Blending is further characterized by being conducted at a temperature less than or equal to 150° C., or at 80 to 150° C., or at 100-150° C. Blending times can be determined by the skilled person and are typically in the range of 5 minutes to 2 hours. Optionally, blending can be conducted in the absence of epoxy resin, or in the absence of any thermoset resin.

In a very specific embodiment of the method of forming a hardener composition, the hydroxyl-diterminated poly(phenylene ether) comprises a copolymer of 2,6-xylenol and 2,2-bis(3,5-dimethyl-4-hydroxyphenyl)propane having an intrinsic viscosity of 0.05 to 0.15 deciliter per gram; in structure (1), q is 1, R^{a} is methyl, and X is —CH₂—; the composition comprises 20 to 60 weight percent of the hydroxyl-diterminated poly(phenylene ether), and 40 to 80 weight percent of the anhydride having structure (1); the composition excludes thermoset resin; said blending is conducted at a temperature of 100 to 150° C.; and the single glass transition temperature has a value of −40 to +1° C.

Another embodiment is a curable composition comprising: a hydroxyl-diterminated poly(phenylene ether) having an intrinsic viscosity of 0.03 to 0.2 deciliter per gram measured by Ubbelohde viscometer at 25° C. in chloroform; an anhydride having structure (1)

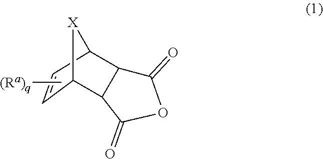

wherein q is zero or 1, R^{a} is C₁₋₆-alkyl, and X is —CH₂—, —(CH₂)₂—, —O—, or —S—; and an epoxy resin; wherein the hydroxyl-diterminated poly(phenylene ether), the anhydride having structure (1), and the epoxy resin are present in amounts effective to produce a mole ratio of epoxy groups derived from the epoxy resin to hydroxyl groups derived from the hydroxyl-diterminated poly(phenylene ether) of 5:1 to 400:1, and a mole ratio of epoxy groups derived from the epoxy resin to anhydride groups derived from anhydride having structure (1) of 0.5:1 to 50:1.

All of the above-described variations associated with the hydroxyl-diterminated poly(phenylene ether) and the anhydride having structure (1) apply as well to the use of these components in the curable composition. For example, the hydroxyl-diterminated poly(phenylene ether) can have an intrinsic viscosity of 0.03 to 0.2 deciliter per gram, or 0.04 to 0.17 deciliter per gram, or 0.05 to 0.15 deciliter per gram.

In addition to the hydroxyl-diterminated poly(phenylene ether) and the anhydride having structure (1), the curable composition comprises an epoxy resin. Suitable epoxy resins include, for example, N-glycidyl phthalimide, N-glycidyl tetrahydrophthalimide, phenyl glycidyl ether, p-butylphenyl glycidyl ether, styrene oxide, neohexene oxide, ethylene glycol diglycidyl ether, polyethylene glycol diglycidyl ether, propylene glycol diglycidyl ether, polypropylene glycol diglycidyl ether, tetramethyleneglycol diglycidyl ether, polytetramethylene glycol diglycidyl ether, adipic acid diglycidyl ester, sebacic acid diglycidyl ester, phthalic acid diglycidyl ester, bisphenol A diglycidyl ether, bisphenol F diglycidyl ether, bisphenol S diglycidyl ether, resorcinol diglycidyl ether, tetraglycidyldiaminodiphenylmethane, oligomers of the foregoing compounds, glycidyl ethers of phenol-formaldehyde novolac, glycidyl ethers of cresol-formaldehyde novolac, glycidyl ethers of t-butylphenol-formaldehyde novolac, glycidyl ethers of sec-butylphenol-formaldehyde novolac, glycidyl ethers of tert-octylphenol-formaldehyde novolac, glycidyl ethers of cumylphenol-formaldehyde novolac, glycidyl ethers of decylphenol-formaldehyde novolac, glycidyl ethers of bromophenol-formaldehyde novolac, glycidyl ethers of chlorophenol-formaldehyde novolac, glycidyl ethers of phenol-bis(hydroxymethyl)benzene novolac, glycidyl ethers of phenol-bis(hydroxymethylbiphenyl) novolac, glycidyl ethers of phenol-hydroxybenzaldehyde novolac, glycidyl ethers of phenol-dicyclopentadiene novolac, glycidyl ethers of naphthol-formaldehyde novolac, glycidyl ethers of naphthol-bis(hydroxymethyl)benzene novolac, glycidyl ethers of naphthol-bis(hydroxymethylbiphenyl) novolac, glycidyl ethers of naphthol-hydroxybenzaldehyde novolac, glycidyl ethers of naphthol-dicyclopentadiene novolac, triglycidyl ether of p-aminophenol, glycidyl ethers of cresol-formaldehyde novolac, BPA novolac epoxy, diglycidylether of 1,4butane diol, epoxidized soybean oil, epoxidized castor oil, diglycidyl ether of neopentyl glycol, 2-ethylhexyl glycidyl ether, butyl glycidyl ether, phenyl glycidyl ether, t-butyl glycidyl ether, o-cresyl glycidyl ether, nonyl phenol glycidyl ether, cyclohexane dimethanol diglycidyl ether, trimethylol ethane triglycidyl ether, trimethylol propane triglycidyl ether, tetra glycidyl ether of meta-xylenediamine, tetraglycidyl ether of tetraphenolethane, dicyclopentadiene dioxide, 3,4-epoxy-cyclohexyl-methyl-3,4-epoxy-cyclohexyl carboxylate, diglycidyl ether of d-hydroxy naphthalene, and combinations thereof. In some embodiments, the epoxy resin is selected from the group consisting of bisphenol A diglycidyl ethers, triglycidyl ethers, tetraglycidyl ethers (including tetraglycidyl-4,4′-diaminodiphenylmethane), cresol novolac epoxy resins, phenol novolac epoxy resins, triglycidyl-p-aminophenol, glycidyl ethers of aromatic amines, glycidyl ethers of novolac resins, and combinations thereof.

The hydroxyl-diterminated poly(phenylene ether) and the epoxy resin are present in amounts effective to produce a mole ratio of epoxy groups derived from the epoxy resin to hydroxyl groups derived from the hydroxyl-diterminated poly(phenylene ether) of 5:1 to 400:1. Within this range, the mole ratio of epoxy groups derived from the epoxy resin to hydroxyl groups derived from the hydroxyl-diterminated poly(phenylene ether) can be 10:1 to 200:1, or 10:1 to 100:1.

The anhydride having structure (1) and the epoxy resin are present in amounts effective to produce a mole ratio of epoxy groups derived from the epoxy resin to anhydride groups derived from anhydride having structure (1) of 0.5:1 to 50:1. Within this range, the mole ratio of epoxy groups derived from the epoxy resin to anhydride groups derived from anhydride having structure (1) can be 1:1 to 20:1, or 1.5:1 to 10:1.

In addition to the hydroxyl-diterminated poly(phenylene ether), the anhydride having structure (1), and the epoxy resin, the curable composition can optionally further include fillers, reinforcing agents, additives, or a combination thereof.

Suitable fillers and reinforcing agents may be in the form of nanoparticles, that is, particles with a median particle size (D₅₀) smaller than 100 nanometers as determined using light scattering methods. Useful fillers or reinforcing agents include, for example, silicates and silica powders such as aluminum silicate (mullite), synthetic calcium silicate, zirconium silicate, fused silica, crystalline silica graphite, and natural silica sand; boron powders such as boron-nitride powder, and boron-silicate powders; oxides such as TiO₂, aluminum oxide, and magnesium oxide; calcium sulfate (as its anhydride, dihydrate or trihydrate); calcium carbonates such as chalk, limestone, marble, and synthetic precipitated calcium carbonates; talc, including fibrous, modular, needle shaped, and lamellar talc; wollastonite; surface-treated wollastonite; glass spheres such as hollow and solid glass spheres, silicate spheres, cenospheres, and aluminosilicate spheres (armospheres); kaolin, including hard kaolin, soft kaolin, calcined kaolin, and kaolin comprising various coatings known in the art to facilitate compatibility with the polymeric matrix resin; single crystal fibers or “whiskers” such as silicon carbide, alumina, boron carbide, iron, nickel, and copper whiskers; fibers (including continuous and chopped fibers) such as carbon fibers (including carbon nanofibers), glass fibers (such as E, A, C, ECR, R, S, D, and NE glass fibers), basalt fibers, ceramic fibers, aramid fibers (including poly(p-phenylene terephthalamide) fibers), boron fibers, liquid crystal fibers, and polyethylene fibers; sulfides such as molybdenum sulfide, and zinc sulfide; barium compounds such as barium titanate, barium ferrite, barium sulfate, and heavy spar; metals and metal oxides such as particulate and fibrous aluminum, bronze, zinc, copper and nickel; flaked fillers such as glass flakes, flaked silicon carbide, aluminum diboride, aluminum flakes, and steel flakes; inorganic fibrous fillers, for example short inorganic fibers such as those derived from blends comprising at least one of aluminum silicates, aluminum oxides, magnesium oxides, and calcium sulfate hemihydrate; natural fillers and reinforcements, such as wood flour obtained by pulverizing wood, fibrous products such as cellulose, cotton, sisal, jute, starch, cork flour, lignin, ground nut shells, corn, and rice grain husks; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, and poly(vinyl alcohol); as well as additional fillers and reinforcing agents such as mica, clay, feldspar, flue dust, fillite, quartz, quartzite, perlite, tripoli, diatomaceous earth, and carbon black; as well as combinations of the foregoing fillers and reinforcing agents. When present, fillers and reinforcing agents are typically present in an amount of 5 to 90 weight percent, based on the total weight of the cured epoxy material. Within this range, the content of fillers and reinforcing agents can be 10 to 80 weight percent, or 20 to 80 weight percent, or 40 to 80 weight percent, or 50 to 80 weight percent.

Suitable additives include curing promoter for epoxy resin (described above in the context of the hardener composition), colorants (including dyes and pigments), antioxidants, heat stabilizers, light stabilizers, plasticizers, lubricants, flow modifiers, drip retardants, flame retardants, antistatic agents, flow-promoting agents, processing aids, substrate adhesion agents, mold release agents, toughening agents, low-profile additives, stress-relief additives, and combinations thereof. When present, additives are typically used in an amount of 0.5 to 10 weight percent, specifically 1 to 5 weight percent, based on the total weight of the curable composition.

In a very specific embodiment of the curable composition, the hydroxyl-diterminated poly(phenylene ether) comprises a copolymer of 2,6-xylenol and 2,2-bis(3,5-dimethyl-4-hydroxyphenyl)propane having an intrinsic viscosity of 0.05 to 0.15 deciliter per gram; in structure (1), q is 1, R^{a} is methyl, and X is —CH₂—; the epoxy resin is selected from the group consisting of bisphenol A diglycidyl ethers, triglycidyl ethers, tetraglycidyl ethers, cresol novolac epoxy resins, phenol novolac epoxy resins, triglycidyl-p-aminophenol, glycidyl ethers of aromatic amines, glycidyl ethers of novolac resins, and combinations thereof; and the curable composition comprises the hydroxyl-diterminated poly(phenylene ether), the anhydride having structure (1), and the epoxy resin in amounts effective to produce a mole ratio of epoxy groups derived from the epoxy resin to hydroxyl groups derived from the hydroxyl-diterminated poly(phenylene ether) of 10:1 to 200:1, and a mole ratio of epoxy groups derived from the epoxy resin to anhydride groups derived from anhydride having structure (1) of 1:1 to 20:1.

Another embodiment is a cured composition comprising the product of at least partially curing the curable composition in any of its above-described variations. Conditions to achieve partial or full curing can be determined by the skilled person. As demonstrated in the working examples below, curing is typically conducted at a series of increasing temperatures. In some embodiments, curing the curable composition is conducted at a maximum temperature of 170 to 250° C., or 180 to 240° C., or 190 to 235° C.

In some embodiments, the cured composition exhibits a single glass transition temperature in the temperature range 150 to 225° C.; wherein the single glass transition temperature has a value of 180 to 220° C.

Another embodiment is an article comprising the cured composition in any of its variations. Suitable articles include protective coatings, adhesives, electronic laminates (such as those used in the fabrication of computer circuit boards), flooring and paving applications, glass fiber-reinforced pipes, and automotive parts (including leaf springs, pumps, and electrical components). The cured composition is particularly useful in the formation of reinforced composites. Thus, in some embodiments the article is a composite comprising the cured epoxy composition and further comprising a unidirectional or multidirectional reinforcement comprising fibers, preferably substantially continuous fibers, selected from the group consisting of carbon fibers, glass fibers, basalt fibers, ceramic fibers, aramid fibers, boron fibers, liquid crystal fibers, and polyethylene fibers. Multidirectional reinforcements can be woven (such as woven carbon fiber and glass cloth) or non-woven.

In some embodiments, the article is a composite core for an aluminum conductor composite core reinforced cable; wherein the composite core comprises two or more types of longitudinally oriented and substantially continuous reinforcing fibers selected from the group consisting of carbon fibers, basalt fibers, glass fibers, ceramic fibers, aramid fibers, boron fibers, liquid crystal fibers, and polyethylene fibers; and a cured epoxy material surrounding the reinforcing fibers, wherein the cured epoxy material is the cured composition described herein; and the composite core comprises at least 50 volume percent fiber.

Suitable methods of forming such articles include prepregging followed by lamination; resin transfer molding; and pultrusion, compression molding, thermoforming, pressure forming, hydroforming, vacuum forming, and the like. Combinations of the foregoing article fabrication methods can be used.

The invention includes at least the following embodiments.

Embodiment 1: A hardener composition comprising, based on the total weight of the hardener composition: 1 to 80 weight percent of a hydroxyl-diterminated poly(phenylene ether) having an intrinsic viscosity of 0.03 to 0.2 deciliter per gram measured by Ubbelohde viscometer at 25° C. in chloroform; and 20 to 99 weight percent of an anhydride having structure (1)

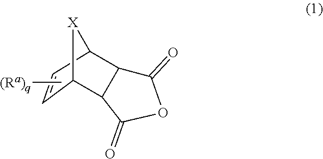

wherein q is zero or 1, R^{a} is C₁₋₆-alkyl, and X is —CH₂—, —(CH₂)₂—, —O—, or —S—; wherein the hardener composition exhibits a single glass transition temperature in the range −80 to +200° C., wherein the single glass transition temperature has a value of −46 to +110° C.; and wherein the hardener composition comprises zero to 1 weight percent total of solvents for the hydroxyl-diterminated poly(phenylene ether).

Embodiment 2: The hardener composition of embodiment 1, excluding epoxy resin.

Embodiment 3: The hardener composition of embodiment 1 or 2, wherein the hydroxyl-diterminated poly(phenylene ether) has the structure

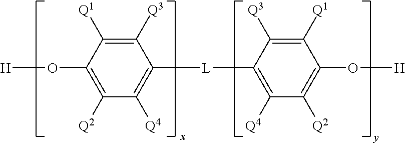

wherein each occurrence of Q¹ and Q² is independently selected from the group consisting of halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; each occurrence of Q³ and Q⁴ is independently selected from the group consisting of hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; x and y are independently 0 to 30, or 0 to 20, or 0 to 15, or 0 to 10, or 0 to 8, provided that the sum of x and y is at least 2, or at least 3, or at least 4; and L has the structure

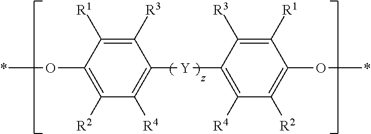

wherein each occurrence of R¹ and R² and R³ and R⁴ is independently selected from the group consisting of hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; z is 0 or 1; and Y is selected from the group consisting of

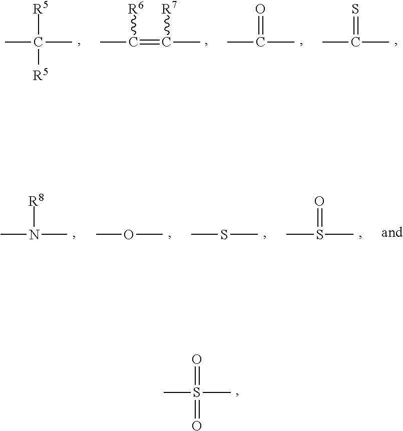

wherein each occurrence of R⁵-R⁸ is independently hydrogen, C₁-C₁₂ hydrocarbyl, or C₁-C₆ hydrocarbylene wherein the two occurrence of R³ collectively form a C₄-C₁₂ alkylene group.

Embodiment 4: The hardener composition of any one of embodiments 1-3, wherein the hydroxyl-diterminated poly(phenylene ether) comprises a copolymer of 2,6-xylenol and 2,2-bis(3,5-dimethyl-4-hydroxyphenyl)propane.

Embodiment 5: The hardener composition of any one of embodiments 1-4, wherein q is 1.

Embodiment 6: The hardener composition of any one of embodiments 1-5, wherein the anhydride having structure (1) is selected from the group consisting of 5-norbornene-2,3-dicarboxylic anhydride, methyl-5-norbornene-2,3-dicarboxylic anhydride, ethyl-5-norbornene-2,3-dicarboxylic anhydride, propyl-5-norbornene-2,3-dicarboxylic anhydride, iso-propyl-5-norbornene-2,3-dicarboxylic anhydride, butyl-5-norbornene-2,3-dicarboxylic anhydride, sec-butyl-5-norbornene-2,3-dicarboxylic anhydride, tert-butyl-5-norbornene-2,3-dicarboxylic anhydride, pentyl-5-norbornene-2,3-dicarboxylic anhydride, neo-pentyl-5-norbornene-2,3-dicarboxylic anhydride, hexyl-5-norbornene-2,3-dicarboxylic anhydride, cyclohexyl-5-norbornene-2,3-dicarboxylic anhydride, and combinations thereof.

Embodiment 7: The hardener composition of any one of embodiments 1-5, wherein q is 1, R^{a} is methyl, and X is —CH₂—.

Embodiment 8: The hardener composition of any one of embodiments 1-7, further comprising 0.005 to 1 weight percent of a curing promoter for epoxy resin.

Embodiment 9: The hardener composition of embodiment 1, wherein the hydroxyl-diterminated poly(phenylene ether) comprises a copolymer of 2,6-xylenol and 2,2-bis(3,5-dimethyl-4-hydroxyphenyl)propane having an intrinsic viscosity of 0.05 to 0.15 deciliter per gram; in structure (1), q is 1, R^{a} is methyl, and X is —CH₂—; the composition comprises 20 to 60 weight percent of the hydroxyl-diterminated poly(phenylene ether), and 40 to 80 weight percent of the anhydride having structure (1); the composition excludes thermoset resin; and the single glass transition temperature has a value of −40 to +1° C.

Embodiment 10: A method of forming a hardener composition, the method comprising: blending, based on the total weight of the hardener composition, 1 to 80 weight percent of a hydroxyl-diterminated poly(phenylene ether) having an intrinsic viscosity of 0.03 to 0.2 deciliter per gram measured by Ubbelohde viscometer at 25° C. in chloroform; and 20 to 99 weight percent of an anhydride having structure (1)

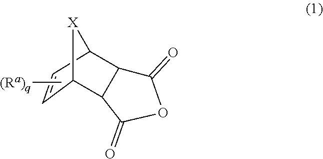

wherein q is zero or 1, R^{a} is C₁₋₆-alkyl, and X is —CH₂—, —(CH₂)₂—, —O—, or —S—, to form the composition; wherein said blending is conducted in the presence of less than or equal to 1 weight percent total of solvents for the hydroxyl-diterminated poly(phenylene ether); wherein said blending is conducted at a temperature less than or equal to 150° C. ; and wherein the composition exhibits a single glass transition temperature in the range −80 to +200° C., wherein the single glass transition temperature has a value of −46 to +110° C.

Embodiment 11: The method of embodiment 10, wherein said blending is conducted in the absence of epoxy resin.

Embodiment 12: The method of embodiment 10, wherein the hydroxyl-diterminated poly(phenylene ether) comprises a copolymer of 2,6-xylenol and 2,2-bis(3,5-dimethyl-4-hydroxyphenyl)propane having an intrinsic viscosity of 0.05 to 0.15 deciliter per gram; in structure (1), q is 1, R^{a} is methyl, and X is —CH₂—; the composition comprises 20 to 60 weight percent of the hydroxyl-diterminated poly(phenylene ether), and 40 to 80 weight percent of the anhydride having structure (1); the composition excludes thermoset resin; said blending is conducted at a temperature of 100 to 150° C.; and the single glass transition temperature has a value of −40 to +1° C.

Embodiment 13: A curable epoxy composition comprising: a hydroxyl-diterminated poly(phenylene ether) having an intrinsic viscosity of 0.03 to 0.2 deciliter per gram measured by Ubbelohde viscometer at 25° C. in chloroform; an anhydride having structure (1)

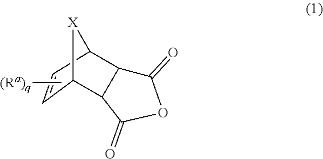

wherein q is zero or 1, R^{a} is C₁₋₆-alkyl, and X is —CH₂—, —(CH₂)₂—, —O—, or —S—; and an epoxy resin; wherein the hydroxyl-diterminated poly(phenylene ether), the anhydride having structure (1), and the epoxy resin are present in amounts effective to produce a mole ratio of epoxy groups derived from the epoxy resin to hydroxyl groups derived from the hydroxyl-diterminated poly(phenylene ether) of 5:1 to 400:1, and a mole ratio of epoxy groups derived from the epoxy resin to anhydride groups derived from anhydride having structure (1) of 0.5:1 to 50:1.

Embodiment 14: The curable epoxy composition of embodiment 13, wherein the epoxy resin is selected from the group consisting of N-glycidyl phthalimide, N-glycidyl tetrahydrophthalimide, phenyl glycidyl ether, p-butylphenyl glycidyl ether, styrene oxide, neohexene oxide, ethylene glycol diglycidyl ether, polyethylene glycol diglycidyl ether, propylene glycol diglycidyl ether, polypropylene glycol diglycidyl ether, tetramethyleneglycol diglycidyl ether, polytetramethylene glycol diglycidyl ether, adipic acid diglycidyl ester, sebacic acid diglycidyl ester, phthalic acid diglycidyl ester, bisphenol A diglycidyl ether, bisphenol F diglycidyl ether, bisphenol S diglycidyl ether, resorcinol diglycidyl ether, tetraglycidyldiaminodiphenylmethane, oligomers of the foregoing compounds, glycidyl ethers of phenol-formaldehyde novolac, glycidyl ethers of cresol-formaldehyde novolac, glycidyl ethers of t-butylphenol-formaldehyde novolac, glycidyl ethers of sec-butylphenol-formaldehyde novolac, glycidyl ethers of tert-octylphenol-formaldehyde novolac, glycidyl ethers of cumylphenol-formaldehyde novolac, glycidyl ethers of decylphenol-formaldehyde novolac, glycidyl ethers of bromophenol-formaldehyde novolac, glycidyl ethers of chlorophenol-formaldehyde novolac, glycidyl ethers of phenol-bis(hydroxymethyl)benzene novolac, glycidyl ethers of phenol-bis(hydroxymethylbiphenyl) novolac, glycidyl ethers of phenol-hydroxybenzaldehyde novolac, glycidyl ethers of phenol-dicyclopentadiene novolac, glycidyl ethers of naphthol-formaldehyde novolac, glycidyl ethers of naphthol-bis(hydroxymethyl)benzene novolac, glycidyl ethers of naphthol-bis(hydroxymethylbiphenyl) novolac, glycidyl ethers of naphthol-hydroxybenzaldehyde novolac, glycidyl ethers of naphthol-dicyclopentadiene novolac, triglycidyl ether of p-aminophenol, glycidyl ethers of cresol-formaldehyde novolac, BPA novolac epoxy, diglycidylether of 1,4 butane diol, epoxidized soybean oil, epoxidized castor oil, diglycidyl ether of neopentyl glycol, 2-ethylhexyl glycidyl ether, butyl glycidyl ether, phenyl glycidyl ether, t-butyl glycidyl ether, o-cresyl glycidyl ether, nonyl phenol glycidyl ether, cyclohexane dimethanol diglycidyl ether, trimethylol ethane triglycidyl ether, trimethylol propane triglycidyl ether, tetra glycidyl ether of meta-xylenediamine, tetraglycidyl ether of tetraphenolethane, dicyclopentadiene dioxide, 3,4-epoxy-cyclohexyl-methyl-3,4-epoxy-cyclohexyl carboxylate, diglycidyl ether of d-hydroxy naphthalene, and combinations thereof.

Embodiment 15: The curable epoxy composition of embodiment 13, wherein the hydroxyl-diterminated poly(phenylene ether) comprises a copolymer of 2,6-xylenol and 2,2-bis(3,5-dimethyl-4-hydroxyphenyl)propane having an intrinsic viscosity of 0.05 to 0.15 deciliter per gram; in structure (1), q is 1, R^{a} is methyl, and X is —CH₂—; the epoxy resin is selected from the group consisting of bisphenol A diglycidyl ethers, triglycidyl ethers, tetraglycidyl ethers, cresol novolac epoxy resins, phenol novolac epoxy resins, triglycidyl-p-aminophenol, glycidyl ethers of aromatic amines, glycidyl ethers of novolac resins, and combinations thereof; and the curable composition comprises the hydroxyl-diterminated poly(phenylene ether), the anhydride having structure (1), and the epoxy resin in amounts effective to produce a mole ratio of epoxy groups derived from the epoxy resin to hydroxyl groups derived from the hydroxyl-diterminated poly(phenylene ether) of 10:1 to 200:1, and a mole ratio of epoxy groups derived from the epoxy resin to anhydride groups derived from anhydride having structure (1) of 1:1 to 20:1.

Embodiment 16: A cured epoxy composition comprising the product of at least partially curing the curable composition of any one of embodiments 13-15.

Embodiment 17: The cured epoxy composition of embodiment 16, exhibiting a single glass transition temperature in the temperature range 150 to 225° C.; wherein the single glass transition temperature has a value of 185 to 215° C.

Embodiment 18: An article comprising the cured epoxy composition of embodiment 16 or 17.

Embodiment 19: The article of embodiment 18, wherein the article is a composite comprising the cured epoxy composition and further comprising a unidirectional or multidirectional reinforcement comprising fibers selected from the group consisting of carbon fibers, glass fibers, basalt fibers, ceramic fibers, aramid fibers, boron fibers, liquid crystal fibers, and polyethylene fibers.

Embodiment 20: The article of embodiment 18, wherein the article is a composite core for an aluminum conductor composite core reinforced cable; wherein the composite core comprises two or more types of longitudinally oriented and substantially continuous reinforcing fibers selected from the group consisting of carbon fibers, basalt fibers, glass fibers, ceramic fibers, aramid fibers, boron fibers, liquid crystal fibers, and polyethylene fibers; and a cured epoxy material surrounding the reinforcing fibers, wherein the cured epoxy material comprises the cured composition of embodiment 16 or 17; and wherein said composite core comprises at least 50 volume percent fiber.

The article of embodiment 19, wherein the article is a composite core for an aluminum conductor composite core reinforced cable; wherein the composite core comprises two or more types of longitudinally oriented and substantially continuous reinforcing fibers selected from the group consisting of carbon fibers, basalt fibers, glass fibers, ceramic fibers, aramid fibers, boron fibers, liquid crystal fibers, and polyethylene fibers; and a cured epoxy material surrounding the reinforcing fibers, wherein the cured epoxy material comprises the cured composition of embodiment 16 or 17; and wherein said composite core comprises at least 50 volume percent fiber.

All ranges disclosed herein are inclusive of the endpoints, and the endpoints are independently combinable with each other. Each range disclosed herein constitutes a disclosure of any point or sub-range lying within the disclosed range.

The invention is further illustrated by the following non-limiting examples.

### EXAMPLES

Components used to form curable epoxy resin compositions are summarized in Table 1.

TABLE 1

| Component | Description |
|---|---|
| TGDDM | Tetraglycidyldiaminodiphenylmethane, CAS Reg. No. 28768-32-3; |
| | obtained as ARALDITE ™ MY 721 from Huntsman Advanced |
| | Materials. |
| Me-NADIC | Methyl-5-norbornene-2,3-dicarboxylic anhydride, CAS Reg. No. |
| | 25134-21-8; obtained from Sigma-Aldrich. |
| NADIC | cis-5-Norbornene-endo-2,3-dicarboxylic anhydride, CAS Reg. No. |
| | 129-64-6; obtained from Sigma-Aldrich. |
| HHPA | Hexahydrophthalic anhydride; CAS Reg. No. 85-42-7; obtained from |
| | Miller Stephenson Co. |
| PPE-2OH 0.06 | Copolymer of 2,2-bis(3,5-dimethyl-4-hydroxyl)propane and |
| | 2,6-dimethylphenol, CAS Reg. No. 1012321-47-9, the copolymer |
| | having an average of about 2 hydroxyl groups per molecule, a |
| | hydroxyl equivalent weight of about 681 grams/equivalent, a glass |
| | transition temperature of about 100° C., and an intrinsic viscosity of |
| | about 0.06 deciliter per gram measured by Ubbelohde viscometer at |
| | 25° C. in chloroform; preparable according to the procedure of |
| | Example 1 of U.S. Pat. No. 8,053,077 to Braidwood et al., issued 8 |
| | Nov. 2011. |
| PPE-2OH 0.09 | Copolymer of 2,2-bis(3,5-dimethyl-4-hydroxyl)propane and 2,6- |
| | dimethylphenol, CAS Reg. No. 1012321-47-9, the copolymer having |
| | an average of about 2 hydroxyl groups per molecule, a hydroxyl |
| | equivalent weight of about 872 grams/equivalent, a glass transition |
| | temperature of about 150° C., and an intrinsic viscosity of about 0.09 |
| | deciliter per gram measured by Ubbelohde viscometer at 25° C. in |
| | chloroform; obtained as PPO ™ SA90 Resin from SABIC. |
| PPE-2OH 0.12 | Copolymer of 2,2-bis(3,5-dimethyl-4-hydroxyl)propane and 2,6- |
| | dimethylphenol, CAS Reg. No. 1012321-47-9, the copolymer having |
| | an average of about 2 hydroxyl groups per molecule, a hydroxyl |
| | equivalent weight of about 1597 grams/equivalent, a glass transition |
| | temperature of about 170° C., and an intrinsic viscosity of about 0.12 |
| | deciliter per gram measured by Ubbelohde viscometer at 25° C. in |
| | chloroform; preparable according to the procedure of Example 3 of |
| | U.S. Pat. No. 8,053,077 to Braidwood et al., issued 8 Nov. |
| | 2011. |
| 1-MeI | 1-Methylimidazole; CAS Reg. No. 616-47-7; obtained from |
| | Sigma-Aldrich. |
| NPG DGE | Neopentyl glycol diglycidyl ether, CAS Reg. No. 17557-23-2, with |
| | an epoxy equivalent weight of 128 grams/equivalent obtained as |
| | ERISYS ™ GE-20 from Emerald Performance Materials |
| ECHM | 3,4-Epoxycyclohexanemethyl 3,4-epoxycyclohexanecarboxylate, |
| | CAS Reg. No. 2386-87-0 with an epoxy equivalent weight of 137 |
| | grams/equivalent; obtained as ARALDITE ™ CY 179 from |
| | Huntsman. |
| DMAP | 4-(Dimethylamino)pyridine, CAS Reg. No. 1122-58-3; obtained from |
| | Sigma-Aldrich. |

### Comparative Examples A and B

The negative effects of using high temperature to dissolve poly(phenylene ether) in epoxy resin, and the effect of high temperature on the reaction of the poly(phenylene ether) with the epoxy, is shown in Comparative Examples A and B.

Methyl ethyl ketone (MEK; 2-butanone) was used to prepare homogenous mixtures without any significant heat. Hence, 99 grams of TGDDM and 32 grams of PPPE-2OH 0.09 were dissolved in 50 grams of MEK. For Comparative Example A, the solvent was removed from half the solution using a rotary evaporator where the temperature of the water bath never exceeded 50° C. The material was then transferred to tray, placed in a vacuum oven for 18 hours at ambient temperature, and then removed and analyzed.

Comparative Example B simulated the higher temperature that would be used for dissolution of poly(phenylene ether) in epoxy resin. Thus the other half of the MEK solution was placed in a beaker and heated until the temperature reached 120° C. After one hour the blend was cool and analyzed.

Glass transition temperatures, expressed in degrees centigrade, were determined by differential scanning calorimetry (DSC) using a heating rate of 20° C./minute and a temperature range of −80 to 200° C. Viscosities, expressed in units of centipoise (cPs), were measured using a Brookfield digital spindle viscometer, Model DV-II, equipped with a Thermosel System for elevated temperature testing. The procedure in the viscometer's Manufacturing Operation Manual No: m/85-160-G was followed. Samples were placed in the disposable Spindle/Chambers assemble and the temperature was adjusted to the test temperature (25, 50, or 75° C.). After equilibration for 5 minutes at the test temperature, the viscosity was determined. Results are presented in Table 2.

TABLE 2

| | T_{g} | Viscosity, | Viscosity, | Viscosity, |
|---|---|---|---|---|
| | (° C.) | 25° C. (cPs) | 50° C. (cPs) | 75° C. (cPs) |
| Comp. Ex. A | −15.71 | 10,900 | 1,300 | 440 |
| Comp. Ex. B | −9.81 | 650,000 | 112,000 | 37,800 |

The results suggest that using heat to dissolve poly(phenylene ether) in the epoxy results in the poly(phenylene ether) reacting with the epoxy to give a higher molecular weight adduct which significantly increased the viscosity. This large increase in viscosity has negative implications on processability, and wet-out of fibers, fillers, and surfaces, For example in resin transfer molding, where a glass pre-form is placed in a mold and resin is injected into the mold, a higher viscosity resin would require higher injection pressure. In addition, the force of the high viscosity resin could move part of the glass pre-form.

### Examples 1-8, Comparative Example C

Homogeneous solutions were prepared by adding PPE-2OH 0.09 into Me-NADIC with heat and stirring at a temperature that did not exceed 150° C. After the PPE-2OH 0.09 was completely dissolved, the material was cooled to ambient temperature to yield a homogeneous liquid. This is evident in the liquid composition's glass transition temperature (T_{g}) of −44 to 32° C. and the absence of any other glass transition temperatures in the range −80 to 200° C. Comparative Example A showed a T_{g} of −47.8° C. for Me-NADIC. Results are summarized in Table 3 for various concentrations of PPE-2OH 0.09 in Me-NADIC. Glass transition temperatures were determined by differential scanning calorimetry (DSC) using a heating rate of 20° C./minute and a temperature range of −80 to 200° C.

TABLE 3

| | PPE-2OH 0.09 (wt %) | Tg (° C.) |
|---|---|---|
| Comp. Example C | 0 | −47.8 |
| Example 1 | 10 | −44.1 |
| Example 2 | 20 | −40.2 |
| Example 3 | 31 | −34.5 |
| Example 4 | 38 | −28.8 |
| Example 5 | 40 | −27.3 |
| Example 6 | 47 | −20.4 |
| Example 7 | 60 | 1.3 |
| Example 8 | 75 | 32.2 |

### Examples 9-12, Comparative Examples D and E

These examples illustrate the temperature dependence of reaction between PPE-2OH 0.09 and Me-NADIC. In a beaker was placed 68 grams of Me-NADIC and 32 grams PPE-OH 0.09, with stirring the beaker and contents were heated to 100-130° C. to dissolve the PPE-OH 0.09. After the blend was homogeneous, the temperature was adjusted to the desired temperature. The temperature of the reagents was determined using a thermocouple probe. After 30 minutes at the desired temperature, a sample was taken for analysis using a pipette. The reaction of PPE-2OH 0.09 was followed by NMR by following the disappearance of hydroxyl groups (phenolic end groups). The average number of hydroxyl groups in the reaction mixture was determined by functionalization with a phosphorus reagent and analysis by ³¹P NMR as described in P. Chan, D. S. Argyropoulos, D. M. White, G. W. Yeager, and A. S. Hay, Macromolecules, 1994, volume 27, pages 6371-6375. Data are presented in Table 3, where “Initial” refers to a sample without heating. Examples 9-12 reveal no significant reaction between PPE-2OH 0.09 and Me-NADIC from 75 to 150° C. Comparative Examples D and E show the onset of significant reaction between PPE-2OH 0.09 and Me-NADIC. Indeed, at 175 and 200° C. there are 12.5 and 49.4% reaction after 30 minutes, respectively. Results are summarized in Table 4.

TABLE 4

| | Temp. (° C.) | Percent Reaction |
|---|---|---|
| | Initial | 0.0 |
| Example 9 | 75.0 | 0.0 |
| Example 10 | 100.0 | 0.0 |
| Example 11 | 125.0 | 0.3 |
| Example 12 | 150.0 | 0.5 |
| Comparative Example D | 175.0 | 12.5 |
| Comparative Example E | 200.0 | 49.4 |

### Example 13, Comparative Example F

The DMAP-catalyzed reactions at 120° C. of PPE-20H 0.09 with HHPA or Me-NADIC reveal that the PPE-20H 0.09 reacts with HHPA but not with Me-NADIC. In a beaker was placed 67 grams of anhydride (NMA or HHPA) and heated to 120° C. The temperature of the reagents was determined using a thermocouple probe. Then 33 grams PPE-2OH 0.09 was added with stirring. After the PPE-2OH 0.09 was dissolved, 0.3 grams of DMAP was added. Samples were taken for analysis using a pipette every 30 minutes. The reaction of PPE-2OH 0.09 was followed by NMR by following the disappearance of hydroxyl groups (phenolic end group). The average number of hydroxyl groups in the reaction mixture was determined by functionalization with a phosphorus reagent and analysis by ³¹P NMR as described in P. Chan, D. S. Argyropoulos, D. M. White, G. W. Yeager, and A. S. Hay, Macromolecules, 1994, volume 27, pages 6371-6375. This further illustrates the exceptional properties of the present blends of a hydroxyl-diterminated poly(phenylene ether) and a particular anhydride having a bridged group. Results are summarized in Table 5.

TABLE 5

| Time at 120° C. | Comparative Example F | Example 13 |
|---|---|---|
| (min) | % Reaction HHPA | % Reaction Me-NADIC |
| 0 | 0 | 0 |
| 30 | 31.6 | 0 |
| 60 | 44.2 | 0 |
| 90 | 51.6 | 0 |
| 120 | 56.8 | 0 |
| 180 | 63.0 | 0 |

### Comparative Examples G and H

Dissolving PPE-2OH 0.09 in the epoxy resin TGDDM at 100 and 120° C. results in reaction between PPE-2OH 0.09 and TGDDM. Time to dissolve, and % reaction after the PPE-2OH 0.09 is totally dissolved is summarized in Table 6. A beaker containing 100 grams of TGDDM was heated to temperature (100 or 120° C.). The temperature of was determined using a thermocouple probe. With stirring, 25 grams PPE-2OH 0.09 were added in 5 gram portions to minimize agglomeration of the undissolved material. The time to dissolve the last portion of the PPE-2OH 0.09 was recorded. A sample was taken using a pipette and stored in a refrigerator until analysis. The reaction of PPE-2OH 0.09 was followed by NMR by following the disappearance of hydroxyl groups (phenolic end group). The average number of hydroxyl groups in the reaction mixture was determined by functionalization with a phosphorus reagent and analysis by ³¹P NMR as described in P. Chan, D. S. Argyropoulos, D. M. White, G. W. Yeager, and A. S. Hay, Macromolecules, 1994, volume 27, pages 6371-6375. There is significant reaction between PPE-2OH 0.09 and TGDDM, which can lead to increases in viscosity and shorter pot life.

TABLE 6

| | | Time for PPE-2OH | |
|---|---|---|---|
| | Temperature | to dissolve | % |
| | (° C.) | (min) | Reaction |
| Comparative Example G | 100 | 75 | 73.2 |
| Comparative Example H | 120 | 55 | 65.4 |

### Examples 14 and 15

Homogeneous solutions were prepared by adding PPE-2OH 0.06 or PPE-2OH 0.12 into Me-NADIC with heat and stirring at a temperature that did not exceed 150° C. After the PPE-2OH 0.06 and PPE-2OH 0.12 were completely dissolved, the material was cooled to ambient temperature to yield a homogeneous liquid. Results are summarized in Table 7.

TABLE 7

| | PPE-2OH 0.06 (wt %) | PPE-2OH 0.12 (wt %) | T_{g} (° C.) |
|---|---|---|---|
| Example 14 | 31 | — | −33.3 |
| Example 15 | — | 31 | −35.8 |

### Examples 16 and 17, Comparative Example 1

NADIC has a crystalline melting point of 166° C. Homogeneous solutions were prepared by adding PPE-2OH 0.09 into NADIC with heat and stirring at a temperature that did not exceed 170° C. After the PPE-2OH 0.09 was completely dissolved, the material was cooled to ambient temperature to yield a homogeneous mixture. Results are summarized in Table 8.

TABLE 8

| | PPE-2OH 0.09 (wt %) | Tₘ (° C.) | T_{g} (° C.) |
|---|---|---|---|
| Comparative Example I | 0 | 166 | — |
| Example 16 | 50 | — | 108.8 |
| Example 17 | 75 | — | 95.9 |

### Example 18, Comparative Examples J and K

The effect of sample preparation on glass transition temperature of castings is exemplified by castings prepared from 51.9 parts by weight TGDDM, 33.06 parts by weight Me-NADIC, and 15.04 parts by weight PPE-2OH 0.09, with 0.2 parts by weight 1-methylimidazole catalyst. All parts by weight are based on 100 parts by weight total of TGDDM, Me-NADIC, and PPE-2OH 0.09.

For Comparative Example J, PPE-2OH 0.09 was dissolved in TGDDM at 100° C. for 90 minutes. Then Me-NADIC and catalyst were added, and the resulting mixture was stirred and cured. Curing conditions are detailed below.

For Comparative Example K, PPE-2OH 0.09 was dissolved in and pre-reacted with Me-NADIC at 200° C. for 60 minutes. The resulting mixture was cooled below 100° C., and TGDDM and catalyst were added, and the resulting mixture was stirred and cured.

For Example 18, PPE-2OH 0.09 was dissolved in Me-NADIC at 150° C. for 60 minutes. The resulting blend was cooled below 100° C., and TGDDM and catalyst were added. The resulting mixture was stirred and cured.

All samples were cured in an oven initially pre-heated to 120° C. The temperature profile was as follows:

The temperature was held at 120° C. for 30 minutes.

The temperature was then increased to 150° C. and held for 30 minutes.

The temperature was then increased to 175° C. and held for 30 minutes

The temperature was then increased to 220° C. and held for 30 minutes.

The temperature was then increased to 225° C. and held for 60 minutes. Samples were then removed from the oven and allowed to cool to ambient temperature.

Glass transition temperature values of the cured castings were determined by DSC and are presented in Table 8. Clearly, pre-dissolving the homogeneous blend of PPE-2OH 0.09 and Me-NADIC in making the castings gives a higher T_{g} than pre-dissolving the PPE-2OH in TGDDM. In addition, pre-dissolving the PPE-2OH in Me-NADIC gave similar performance as pre-reacting the PPE-2OH in Me-NADIC.

TABLE 8

| | T_{g} (° C.) |
|---|---|
| Comparative Example J | 178.2 |
| Comparative Example K | 199.8 |
| Example 18 | 197.7 |

### Example 19

308.95 grams of Me-NADIC was heated to 120-150° C. 141.05 grams of PPE-2OH 0.09 was added with stirring. After the PPE-2OH 0.09 was completely dissolved (around 45-90 minutes), the blend was cooled. DSC analysis showed a T_{g} of −34.2° C.

### Example 20

123.21grams of Me-NADIC was heated to 120-150° C. 76.79 grams of PPE-2OH 0.09 was added with stirring. After the PPE-2OH 0.09 was completely dissolved (around 45-90 minutes), the blend was cooled. DSC analysis showed a T_{g} of −28.3° C.

### Example 21

78.41grams of Me-NADIC was heated to 120-150° C. 71.59 grams of PPE-2OH 0.09 was added with stirring. After the PPE-2OH 0.09 was completely dissolved (around 45-90 minutes), the blend was cooled. DSC analysis showed a T_{g} of −19.5° C.

### Example 22

Castings were prepared using the material from Example 19. The material was warmed to 60-70° C. to soften and 95.04 grams were transferred to a beaker. 1.0 gram of 1-MeI was added and dissolved with stirring. 16.08 grams of NPG DGE and 88.89 grams of TGDDM were added and dissolved. The homogeneous blend was degassed under vacuum and then poured into a preheated (100° C.) mold and placed in an oven at 100° C. The temperature was adjusted as follows to cure the resin: the temperature was increased to 120° C., after 60 minutes the temperature increased to 140° C., after 30 minutes the temperature was increased to 150° C., after 30 minutes the temperature was increased to 175° C., after 30 minutes the temperature was increased to 200° C., after 30 minutes the oven was turned off oven and allowed to cool overnight.

Test results showed a T_{g} of 202° C. and a fracture toughness (K_{1c}, critical stress intensity factor) of 0.53 MPa-m^{1/2}.

### Example 23

Castings were prepared using the material from Example 20. The material was warmed to 60-70° C. to soften and 99.11 grams were transferred to a beaker. 1.0 gram of 1-MeI was added and dissolved with stirring. 20.35 grams of NPG DGE and 80.53grams of TGDDM were added and dissolved. The homogeneous blend was degassed under vacuum and then poured into a preheated (100° C.) mold and placed in an oven at 100° C. The temperature was adjusted as follows to cure the resin: the temperature was increased to 120° C., after 60 minutes the temperature increased to 140° C., after 30 minutes the temperature was increased to 150° C., after 30 minutes the temperature was increased to 175° C., after 30 minutes the temperature was increased to 200° C., after 30 minutes the oven was turn off oven and allowed to cool overnight.

Test results showed a T_{g} of 213° C. and a fracture toughness (K_{1c}, critical stress intensity factor) of 0.58 MPa-m^{1/2}.

### Example 24

Castings were prepared using the material from Example 21. The material was warmed to 60-70° C. to soften and 104.76 grams were transferred to a beaker. 1.0 gram of 1-MeI was added and dissolved with stirring. 19.84 grams of NPG DGE, 19.84 grams of ECHM and 55.56 grams of TGDDM were added and dissolved. The homogeneous blend was degassed under vacuum and then poured into a preheated (100° C.) mold and placed in an oven at 100° C. The temperature was adjusted as follows to cure the resin: the temperature was increased to 120° C., after 60 minutes the temperature increased to 140° C., after 30 minutes the temperature was increased to 150° C., after 30 minutes the temperature was increased to 175° C., after 30 minutes the temperature was increased to 200° C., after 30 minutes the oven was turn off oven and allowed to cool overnight.

Test results showed a T_{g} of 186° C. and a fracture toughness (K_{1c}, critical stress intensity factor) of 0.78 MPa-m^{1/2}.

1. A hardener composition comprising, based on the total weight of the hardener composition:
1 to 80 weight percent of a hydroxyl-diterminated poly(phenylene ether) having an intrinsic viscosity of 0.03 to 0.2 deciliter per gram measured by Ubbelohde viscometer at 25° C. in chloroform; and
20 to 99 weight percent of an anhydride having structure (1) 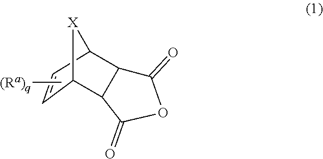
wherein q is zero or 1, R^{a} is C₁₋₆-alkyl, and X is —CH₂—, —(CH₂)₂—, —O—, or —S—;
wherein the hardener composition exhibits a single glass transition temperature in the range −80 to +200° C., wherein the single glass transition temperature has a value of −46 to +110° C.; and
wherein the hardener composition comprises zero to 1 weight percent total of solvents for the hydroxyl-diterminated poly(phenylene ether).

2. The hardener composition of claim 1, excluding epoxy resin.

3. The hardener composition of claim 1, wherein the hydroxyl-diterminated poly(phenylene ether) has the structure 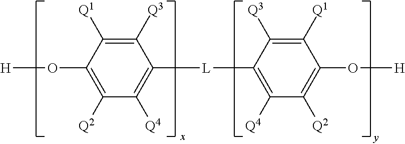
wherein each occurrence of Q¹ and Q² is independently selected from the group consisting of halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; each occurrence of Q³ and Q⁴ is independently selected from the group consisting of hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; x and y are independently 0 to 30, or 0 to 20, or 0 to 15, or 0 to 10, or 0 to 8, provided that the sum of x and y is at least 2, or at least 3, or at least 4; and L has the structure 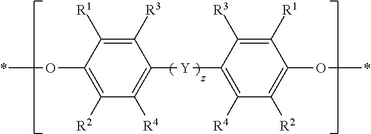
wherein each occurrence of R¹ and R² and R³ and R⁴ is independently selected from the group consisting of hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; z is 0 or 1; and Y is selected from the group consisting of 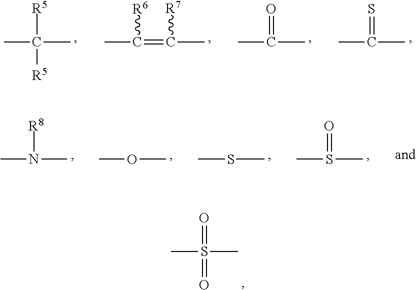
wherein each occurrence of R⁵-R⁸ is independently hydrogen, C₁-C₁₂ hydrocarbyl, or C₁-C₆ hydrocarbylene wherein the two occurrence of R³ collectively form a C₄-C₁₂ alkylene group.

4. The hardener composition of claim 1, wherein the hydroxyl-diterminated poly(phenylene ether) comprises a copolymer of 2,6-xylenol and 2,2-bis(3,5-dimethyl-4-hydroxyphenyl)propane.

5. The hardener composition of claim 1, wherein q is 1.

6. The hardener composition of claim 1, wherein the anhydride having structure (1) is selected from the group consisting of 5-norbornene-2,3-dicarboxylic anhydride, methyl-5-norbornene-2,3-dicarboxylic anhydride, ethyl-5-norbornene-2,3-dicarboxylic anhydride, propyl-5-norbornene-2,3-dicarboxylic anhydride, iso-propyl-5-norbornene-2,3-dicarboxylic anhydride, butyl-5-norbornene-2,3-dicarboxylic anhydride, sec-butyl-5-norbornene-2,3-dicarboxylic anhydride, tent-butyl-5-norbornene-2,3-dicarboxylic anhydride, pentyl-5-norbornene-2,3-dicarboxylic anhydride, neo-pentyl-5-norbornene-2,3-dicarboxylic anhydride, hexyl-5-norbornene-2,3-dicarboxylic anhydride, cyclohexyl-5-norbornene-2,3-dicarboxylic anhydride, and combinations thereof.

7. The hardener composition of claim 1, wherein q is 1, R^{a} is methyl, and X is —CH₂—.

8. The hardener composition of claims 1, further comprising 0.005 to 1 weight percent of a curing promoter for epoxy resin.

9. The hardener composition of claim 1, wherein
the hydroxyl-diterminated poly(phenylene ether) comprises a copolymer of 2,6-xylenol and 2,2-bis(3,5-dimethyl-4-hydroxyphenyl)propane having an intrinsic viscosity of 0.05 to 0.15 deciliter per gram;
in structure (1), q is 1, R^{a} is methyl, and X is —CH₂—;
the composition comprises 20 to 60 weight percent of the hydroxyl-diterminated poly(phenylene ether), and 40 to 80 weight percent of the anhydride having structure (1);
the composition excludes thermoset resin; and
the single glass transition temperature has a value of −40 to +1° C.

10. A method of forming a hardener composition, the method comprising:
blending, based on the total weight of the hardener composition,
1 to 80 weight percent of a hydroxyl-diterminated poly(phenylene ether) having an intrinsic viscosity of 0.03 to 0.2 deciliter per gram measured by Ubbelohde viscometer at 25° C. in chloroform; and
20 to 99 weight percent of an anhydride having structure (1) 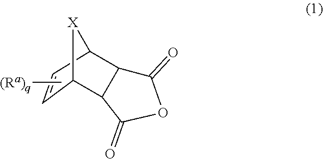
wherein
q is zero or 1,
R^{a} is C₁₋₆-alkyl, and
X is —CH₂—, —(CH₂)₂—, —O—, or —S—, to form the composition;
wherein said blending is conducted in the presence of less than or equal to 1 weight percent total of solvents for the hydroxyl-diterminated poly(phenylene ether);
wherein said blending is conducted at a temperature less than or equal to 150° C.; and
wherein the composition exhibits a single glass transition temperature in the range −80 to +200° C., wherein the single glass transition temperature has a value of −46 to +110° C.

11. The method of claim 10, wherein said blending is conducted in the absence of epoxy resin.

12. The method of claim 10, wherein
the hydroxyl-diterminated poly(phenylene ether) comprises a copolymer of 2,6-xylenol and 2,2-bis(3,5-dimethyl-4-hydroxyphenyl)propane having an intrinsic viscosity of 0.05 to 0.15 deciliter per gram;
in structure (1), q is 1, R^{a} is methyl, and X is —CH₂—;
the composition comprises 20 to 60 weight percent of the hydroxyl-diterminated poly(phenylene ether), and 40 to 80 weight percent of the anhydride having structure (1);
the composition excludes thermoset resin;
said blending is conducted at a temperature of 100 to 150° C.; and
the single glass transition temperature has a value of −40 to +1° C.

13. A curable epoxy composition comprising:
a hydroxyl-diterminated poly(phenylene ether) having an intrinsic viscosity of 0.03 to 0.2 deciliter per gram measured by Ubbelohde viscometer at 25° C. in chloroform;
an anhydride having structure (1) 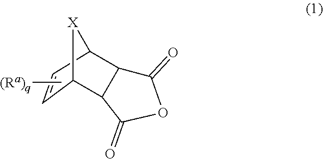
wherein q is zero or 1, R^{a} is C₁₋₆-alkyl, and X is —CH₂—, —(CH₂)₂—, —O—, or —S—; and
an epoxy resin;
wherein the hydroxyl-diterminated poly(phenylene ether), the anhydride having structure (1), and the epoxy resin are present in amounts effective to produce a mole ratio of epoxy groups derived from the epoxy resin to hydroxyl groups derived from the hydroxyl-diterminated poly(phenylene ether) of 5:1 to 400:1, and a mole ratio of epoxy groups derived from the epoxy resin to anhydride groups derived from anhydride having structure (1) of 0.5:1 to 50:1.

14. The curable epoxy composition of claim 13, wherein the epoxy resin is selected from the group consisting of N-glycidyl phthalimide, N-glycidyl tetrahydrophthalimide, phenyl glycidyl ether, p-butylphenyl glycidyl ether, styrene oxide, neohexene oxide, ethylene glycol diglycidyl ether, polyethylene glycol diglycidyl ether, propylene glycol diglycidyl ether, polypropylene glycol diglycidyl ether, tetramethyleneglycol diglycidyl ether, polytetramethylene glycol diglycidyl ether, adipic acid diglycidyl ester, sebacic acid diglycidyl ester, phthalic acid diglycidyl ester, bisphenol A diglycidyl ether, bisphenol F diglycidyl ether, bisphenol S diglycidyl ether, resorcinol diglycidyl ether, tetraglycidyldiaminodiphenylmethane, oligomers of the foregoing compounds, glycidyl ethers of phenol-formaldehyde novolac, glycidyl ethers of cresol-formaldehyde novolac, glycidyl ethers of t-butylphenol-formaldehyde novolac, glycidyl ethers of sec-butylphenol-formaldehyde novolac, glycidyl ethers of tert-octylphenol-formaldehyde novolac, glycidyl ethers of cumylphenol-formaldehyde novolac, glycidyl ethers of decylphenol-formaldehyde novolac, glycidyl ethers of bromophenol-formaldehyde novolac, glycidyl ethers of chlorophenol-formaldehyde novolac, glycidyl ethers of phenol-bis(hydroxymethyl)benzene novolac, glycidyl ethers of phenol-bis(hydroxymethylbiphenyl) novolac, glycidyl ethers of phenol-hydroxybenzaldehyde novolac, glycidyl ethers of phenol-dicyclopentadiene novolac, glycidyl ethers of naphthol-formaldehyde novolac, glycidyl ethers of naphthol-bis(hydroxymethyl)benzene novolac, glycidyl ethers of naphthol-bis(hydroxymethylbiphenyl) novolac, glycidyl ethers of naphthol-hydroxybenzaldehyde novolac, glycidyl ethers of naphthol-dicyclopentadiene novolac, triglycidyl ether of p-aminophenol, glycidyl ethers of cresol-formaldehyde novolac, BPA novolac epoxy, diglycidylether of 1,4 butane diol, epoxidized soybean oil, epoxidized castor oil, diglycidyl ether of neopentyl glycol, 2-ethylhexyl glycidyl ether, butyl glycidyl ether, phenyl glycidyl ether, t-butyl glycidyl ether, o-cresyl glycidyl ether, nonyl phenol glycidyl ether, cyclohexane dimethanol diglycidyl ether, trimethylol ethane triglycidyl ether, trimethylol propane triglycidyl ether, tetra glycidyl ether of meta-xylenediamine, tetraglycidyl ether of tetraphenolethane, dicyclopentadiene dioxide, 3,4-epoxy-cyclohexyl-methyl-3,4-epoxy-cyclohexyl carboxylate, diglycidyl ether of d-hydroxy naphthalene, and combinations thereof.

15. The curable epoxy composition of claim 13, wherein
the hydroxyl-diterminated poly(phenylene ether) comprises a copolymer of 2,6-xylenol and 2,2-bis(3,5-dimethyl-4-hydroxyphenyl)propane having an intrinsic viscosity of 0.05 to 0.15 deciliter per gram;
in structure (1), q is 1, R^{a} is methyl, and X is —CH₂—;
the epoxy resin is selected from the group consisting of bisphenol A diglycidyl ethers, triglycidyl ethers, tetraglycidyl ethers, cresol novolac epoxy resins, phenol novolac epoxy resins, triglycidyl-p-aminophenol, glycidyl ethers of aromatic amines, glycidyl ethers of novolac resins, and combinations thereof; and
the curable composition comprises the hydroxyl-diterminated poly(phenylene ether), the anhydride having structure (1), and the epoxy resin in amounts effective to produce a mole ratio of epoxy groups derived from the epoxy resin to hydroxyl groups derived from the hydroxyl-diterminated poly(phenylene ether) of 10:1 to 200:1, and a mole ratio of epoxy groups derived from the epoxy resin to anhydride groups derived from anhydride having structure (1) of 1:1 to 20:1.

16. A cured epoxy composition comprising the product of at least partially curing the curable composition of claim 13.

17. The cured epoxy composition of claim 16, exhibiting a single glass transition temperature in the temperature range 150 to 225° C.; wherein the single glass transition temperature has a value of 185 to 215° C.

18. An article comprising the cured epoxy composition of claim 16.

19. The article of claim 18, wherein the article is a composite comprising the cured epoxy composition and further comprising a unidirectional or multidirectional reinforcement comprising fibers selected from the group consisting of carbon fibers, glass fibers, basalt fibers, ceramic fibers, aramid fibers, boron fibers, liquid crystal fibers, and polyethylene fibers.

20. The article of claim 18,
wherein the article is a composite core for an aluminum conductor composite core reinforced cable;
wherein the composite core comprises
two or more types of longitudinally oriented and substantially continuous reinforcing fibers selected from the group consisting of carbon fibers, basalt fibers, glass fibers, ceramic fibers, aramid fibers, boron fibers, liquid crystal fibers, and polyethylene fibers; and
a cured epoxy material surrounding the reinforcing fibers, wherein the cured epoxy material comprises the cured composition of claim 16 or 17; and
wherein said composite core comprises at least 50 volume percent fiber.
